(19) United States
(12) Patent Application Publication
(10) Pub. No.: US 2006/0163374 A1
(43) Pub. Date: Jul. 27, 2006

(54) Fountain waterjet

(76) Inventor: Russ Wooten, Oxford, GA (US)

Correspondence Address: LAURENCE P. COLTON, 1201 WEST PEACHTREE STREET, NW, 14TH FLOOR, ATLANTA, GA, 30309-3488, US

(21) Appl. No.: 11/042,667

(22) Filed: Jan. 25, 2005

(51) Int. Cl. F21S 8/00

(52) U.S. Cl. 239/18; 239/587.3; 239/587.4

(57) ABSTRACT

A device for producing a fountain comprising a fountain waterjet, at least one inlet, at least one illumination source, at least one outlet, and at least one transparent conduit to permit transference of light from the illumination source to the water stream in order to produce an illuminated fountain, and preferably having an adjustable and removable fountain forming nozzle so as to be able to vary the size and shape of the fountain and to allow access to the interior of the fountain waterjet for cleaning, maintenance and repair.

### BACKGROUND OF THE INVENTION

1. Technical Field

The present invention generally is in the field of devices for generating fountains, and more particularly is in the field of waterjet devices for generating an aesthetically pleasing illuminated fountain in spas, swimming pools, tubs and the like.

2. Prior Art

Few applications derive more benefit from the addition of waterfalls or fountains than artificial bodies of water such as spas, swimming pools, and tubs. The popularity of waterfalls and fountains in such structures is probably associated with their numerous aesthetic and practical benefits. For example, the addition of a waterfall or fountain to an artificial body of water can provide a substantial decorative effect and a relaxing background sound generated from the water flow. Lighted fountains and waterfalls are even more desirable due to their enhanced visual appeal. In addition, the water circulation associated with waterfalls and fountains can have therapeutic effects and can prevent the water-body from becoming stagnant. As such, users and owners of artificial bodies of water often desire the addition of waterfalls or fountains.

Fountain waterjets typically are unitary devices with the individual parts having been glued, welded or otherwise adhered together. Thus, access to the interior of a fountain waterjet often is impossible. Prior art fountain waterjets can become clogged with debris and/or sediment and, if a unitary device with inadequate access to the interior of the device becomes clogged with debris and/or sediment, such a device likely would have to be removed from the spa, discarded and replaced with another device.

Accordingly, there is a need for a device that allows for the addition of a fountain waterjet to an artificial body of water, such as a spa, swimming pool, tub or the like with a minimum of manufacturing and installation costs. There is also a need for such a device to be able to be adjusted for both the amount and direction of the water stream/fountain, as well as to be able to produce an illuminated fountain. There is a further need for such a device having the advantageous characteristic of simple access to the interior of fountain waterjet to remove debris and/or sediment and to replace illuminating devices without having to resort to discarding the device or having to access difficult areas of the spa. It is to these needs and others that the present invention is directed.

### BRIEF SUMMARY OF THE INVENTION

Briefly described, the present invention is a fountain waterjet that produces an illuminated fountain into a spa, swimming pool, tub, reservoir, or the like, and that is adjustable to alter the direction and flow of the water stream coming from the fountain waterjet. The device also provides a means for filling such a reservoir with water. For simplicity in this disclosure, spas, swimming pools, birdbaths, ponds, tubs or the like, and all such reservoirs and artificial bodies of water, together or separately will be referred to as “spas” or a “spa”.

The invention generally is a device that can be installed on a surface of a spa to provide for the addition of an aesthetically pleasing and decorative fountain that flows into a spa. In the invention, water from a water source flows into the fountain waterjet where it is illuminated before passing out of the fountain waterjet to form a water stream that lands in the spa. Because the device is preferably placed above the surface of the water in the spa, the fountain can be a smooth flow of falling water extending from the fountain waterjet in an arcing pattern until it falls to the surface of the water in the spa.

The fountain waterjet of the present invention generally comprises a water inlet, at least partially transparent tubing and/or conduit, an illumination source, an adjustable flow nozzle, and an outlet screen at a water outlet. It is preferred that the illumination source, transparent tubing, nozzle and outlet are situated axially relative to each other to maximize transference of the light to the water stream so as to provide illumination to the fountain. When the device is in the assembled condition, that is when the various components are installed on the spa, the device appears as a generally continuous shaped structure with the fountain waterjet outlet situated near the center of the fountain waterjet and directed to the spa tub.

The fountain waterjet can be anchored to a surface of a spa, or to a surface proximal to a spa, using any appropriate means as long as water can be fed into, and water can flow out of, the fountain waterjet. In a preferred embodiment, the device can be installed with a minimum of disturbance to the surrounding spa with only a single round hole that may be made with a standard power drill as opposed to typical fountain devices that may require complex cuts and accompanying high costs of installation. The present invention is therefore also can be much less costly to install than other mounted waterfall fountain devices. A further advantage of the present invention is that a user can control the flow of water stream in both quantity (volume) and direction by the manipulation of an easily accessible outlet knob. The device may be installed on a horizontal top surface of a spa or spa deck or on a vertical wall surface of the spa or proximal to the spa.

The device can be used on almost any artificial water body. While the device is described in connection with a spa, it is understood that the device can be used on spas, swimming pools, tubs, and the like. For example, the device can be placed on the edge of a swimming pool so as to provide a fountain into the swimming pool. One of ordinary skill in the art can modify the device without undue experimentation so that it can be placed on almost any artificial water body.

These features, and other features and advantages of the present invention will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 is a side plan view of one embodiment a fountain waterjet according to the present invention.

FIG. 2A is a sectional side view of a top mounting bracket component according to the present invention.

FIG. 2B is a sectional side view of a nozzle mechanism and other internal components according to the present invention.

FIG. 2C is a sectional side view of a bottom mounting bracket component according to the present invention.

FIG. 3 is a sectional side view of the embodiment of FIG. 1 illustrating the present invention as shown in FIGS. 2A-2C assembled.

FIG. 4 is a side plan view of the nozzle component portion of the embodiment shown in FIG. 1 showing a nozzle for controlling the water stream from the fountain waterjet.

FIG. 5 is a front plan view of the embodiment of FIG. 1.

FIGS. 6A-6D are front plan views of illustrative outlet screens according to the present invention.

### DETAILED DESCRIPTION OF THE PREFERRED EMBODIMENTS

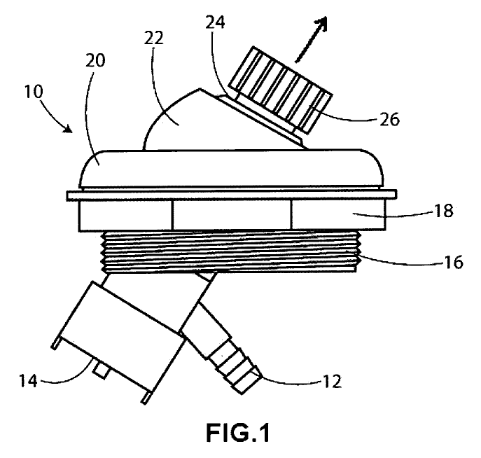

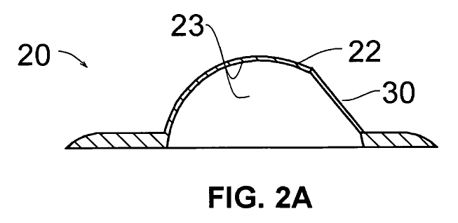

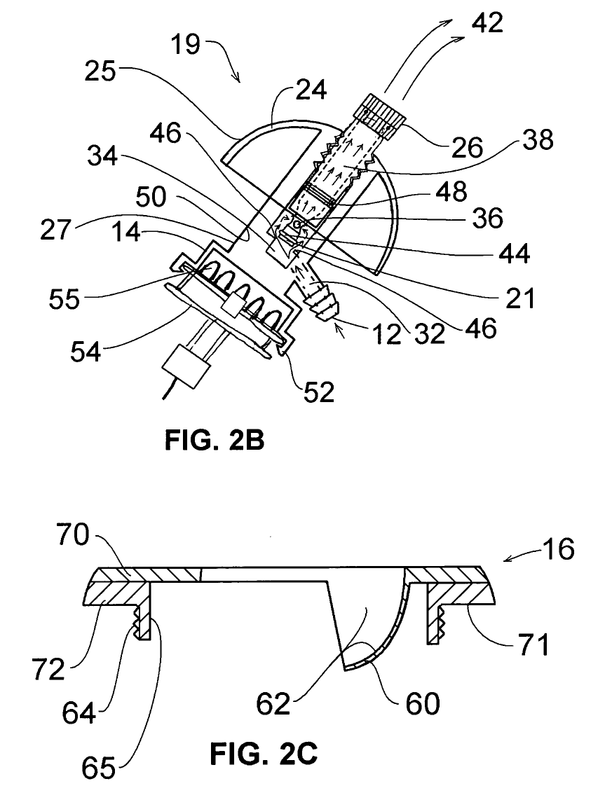

Illustrative embodiments of a fountain waterjet 10 according to the present invention are shown in FIGS. 1 through 6. FIG. 1 is a side view of one embodiment of the present invention showing the invention in an assembled state. FIGS. 2A-2C are sectional side views of preferred embodiments sub-components of the present invention. FIG. 2A is a sectional side view of a top mounting bracket according to the present invention. FIG. 2B is a sectional side view of the internal components according to a preferred embodiment of the present invention. FIG. 2C is a sectional side view of a bottom mounting bracket according to the present invention. The components as shown in FIG. 2B fit rotatably with and are mounted on a spa using the mounting brackets shown in FIGS. 2A and 2C. FIG. 3 is a sectional side schematic view of the embodiment shown in FIG. 1 attached to a spa surface for producing a fountain. In this view, the internal components of the present invention as shown in FIG. 2B are shown mounted rotatably within the mounting brackets shown in FIGS. 2A and 2C.

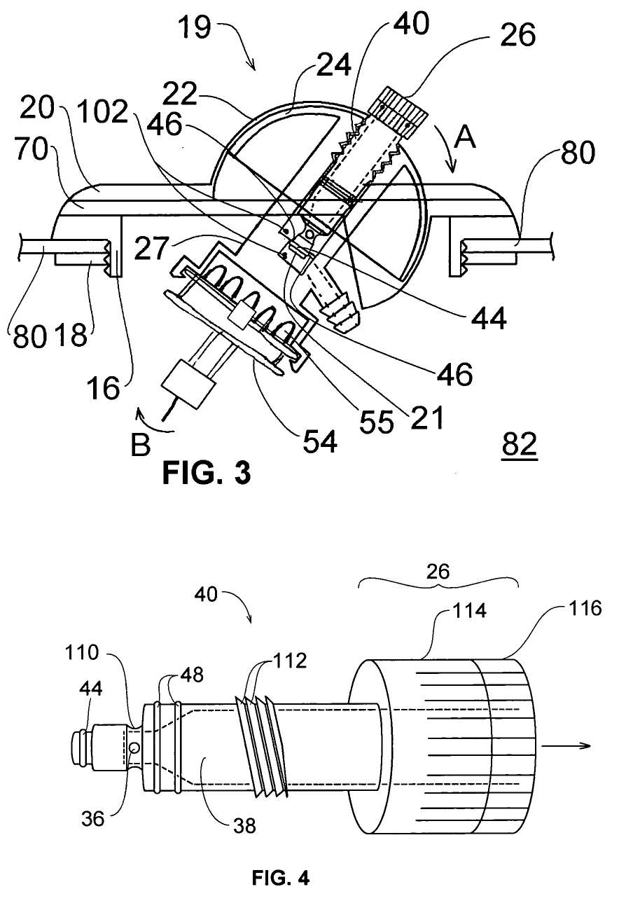

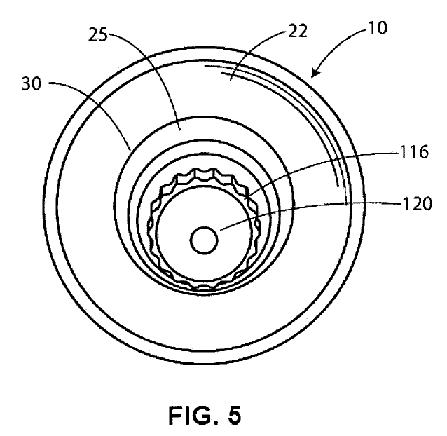

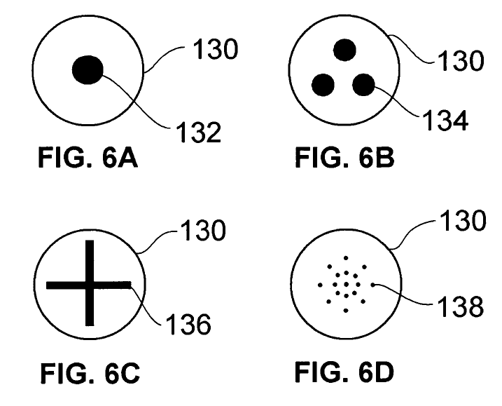

FIG. 4 is a side view of a preferred embodiment of a nozzle for controlling the water stream from the fountain waterjet. FIG. 5 is a front plan view of the invention illustrating the water outlet and an illustrative outlet screen for shaping the fountain. FIG. 6 are illustrative fountain shaping outlet screens. FIG. 6A is a front view of a first illustrative outlet screen according to the present invention including a single round fountain outlet. FIG. 6B is a front view of a second illustrative outlet screen according to the present invention including several outlet holes. FIG. 6C is a front view of a third illustrative outlet screen according to the present invention including a “+” or “x” shaped outlet. FIG. 6D is a front view of a fourth illustrative outlet screen according to the present invention including a plurality of smaller outlet holes. Each of the illustrative outlet screens has the capability of producing a different shaped fountain of water.

FIG. 1 is one illustrative embodiment of the fountain waterjet 10 of the present invention that can provide an aesthetically pleasing and decorative fountain into a spa. FIG. 1 shows a side view of fountain waterjet 10 including water inlet 12, light bracket 14, bottom mounting bracket 16, bottom mounting nut 18, top mounting bracket 20, cover 22, eyeball base 24, and outlet 26. The arrows illustrate the direction of water flow into and out of fountain waterjet 10. Generally speaking, water from a water source (not shown) enters fountain waterjet 10 via inlet 12 where it flows into one or more at least partially transparent conduits and/or chambers, which are disclosed in more detail below in conjunction with FIGS. 2B and 3. An illuminating source affixed to fountain waterjet 10 by way of light bracket 14 shines light into the interior of fountain waterjet 10 and into the water stream carried by the transparent conduits/chambers. The water stream then is carried by way of a nozzle 40, which is disclosed in more detail in conjunction with FIG. 4, out of fountain waterjet 10 through regular fluid dynamics as shown in more detail in the following FIGs. The fountain emanating from nozzle 40 can be shaped or formed using an outlet screen 130, which is disclosed in more detail in conjunction with FIG. 6.

FIGS. 2A-2C illustrate a preferred multi-component configuration for ease of manufacturing, installing and assembling fountain waterjet 10. In this configuration, top mounting bracket 20 of FIG. 2A via cover 22 forms a socket to receive the upper portion of eyeball surface 25 shown in FIG. 2B, with outlet 26 extending through opening 30. Bottom mounting bracket 16 of FIG. 2C completes fountain waterjet 10 and holds via flange 60 the bottom portion of eyeball 25 shown in FIG. 2B. Top mounting bracket 20 and bottom mounting bracket 16 can be secured to one another with the internal components shown in FIG. 2B therebetween and mounted onto a spa. In this preferred configuration, eyeball surface 25 is pivotable when contained between top mounting bracket 20 and bottom mounting bracket 16. Lower mounting bracket 16 is inserted through a hole through the spa surface or another mounting surface corresponding to the shape and size of the lower portion of lower mounting bracket 16, namely threads 64, as disclosed in more detail in conjunction with FIG. 3. Although shown as an interim three-component system, configurations having more or fewer components are within the scope and spirit of this invention.

FIG. 2A shows a sectional side view of top mounting bracket 20. Opening 30 is situated to accommodate the fountain producing end of nozzle 40 including outlet 26 so as to allow nozzle 40 to extend therethrough and to be adjustable for at least a limited distance in direction. Opening 30 can be any shape, and is preferably circular, oval or elliptical when viewed from the front as shown in FIG. 5. Top mounting bracket 20 cover 22 interior surface 23 is preferably spherically shaped such that it mates or cooperates with exterior eyeball surface 25 of base 24.

FIG. 2B shows a sectional side view of the internal structure and nozzle portion of fountain waterjet 10 in more detail. FIG. 2B illustrates the eyeball portion 19 of fountain waterjet 10, which comprises eyeball base 24, eyeball surface 25, eyeball throat 27, and light bracket 14. Water is introduced into eyeball portion 19 through water inlet 12 where it flows through an internal conduit 32 into interim reservoir 34. In the configuration shown in FIG. 2B, fountain waterjet 10 is in an “open” position such that water can pass from internal conduit 32 into interim reservoir 34 and then continues as shown by the arrows to nozzle entrance 36 into nozzle channel 38. In the illustration of FIG. 2B there are two holes that together form nozzle entrance 36 and that allow water access into inner nozzle channel 38 of nozzle 40. Once the water enters nozzle channel 38, the water may continue unencumbered through nozzle channel 38 until it meets an optional outlet screen, discussed in more detail in conjunction with FIGS. 6A-6D, and then out of the fountain waterjet 10 to form fountain 42.

The representative flow control mechanism illustrated is designed such that when nozzle 40 is unscrewed as shown in FIG. 2B, the fountain 42 is at full flow. When the nozzle 40 is screwed all the way in, there is no flow as an o-ring 44 or other sealing means preferably prevents most or all water flow from interim reservoir 34 to nozzle entrance 36 by making contact with interim reservoir surface 46. In the embodiment shown, eyeball throat 27 is a generally cylindrical structure such that interim reservoir surface 46 also is cylindrical in shape and can mate with o-ring 44. Nozzle 40 preferably also includes supplemental o-rings 48 to prevent water from bypassing nozzle 40. Other mechanisms can be used to regulate the flow between interim reservoir 34 and nozzle 40, including variable apertures, rotating dials, pivoting bars or levers, and the like. It is further known that interim reservoir 34 could itself be eliminated with water passing directly from internal conduit 32 to nozzle channel 38, preferably with a means of regulating the flow. Each of these alternative means, as well as others, are known in the art, and it is contemplated that each of these alternative means, as well as others, can be used as the means for regulating the amount of flow between inlet 12 and nozzle 40.

Illumination source 54 provides the light source for illuminating fountain 42 and is attached to light bracket 14 by clips 52. It is preferred that illumination source 54 be a series of light emitting diodes 55 (“LED's”) or similar high intensity, shock-resistant, water-resistant light sources. Thus, it is desirable to construct light bracket 14 such that it may removably receive standard sized 7 and 12 bulb LEDs 55, among others. When illumination source 54 is attached to light bracket 14, light from LEDs 55 is directed through transparent or translucent portions of eyeball throat 27, base 21 of nozzle 40 and into water stream that emanates as fountain 42.

It is preferred that at least some portion of nozzle 40 is transparent to allow light emanating from illumination source 54 to be transmitted to the water stream. It also is preferable that at least some portion of eyeball throat 27, such as but not limited to the walls of interim reservoir 34, is transparent for the same reason. It is more preferred that the walls of all internal conduits and chambers be of transparent material to allow as much transmission of light into the water stream as possible. Several preferred materials for such construction are Plexiglas®, Xylex™, and transparent or translucent plastics, ceramics, minerals, glasses and the like. It also is preferred that at least portions of outlet 16 and outlet screen 130 be constructed of such a transparent or translucent material. Further, internal surfaces 50 can be covered in a mirrored material to further enhance light transference to the water stream.

FIG. 2C shows a sectional side view of bottom mounting bracket 16. Bottom mounting bracket 16 provides a lower flange 60 to retain the eyeball portion base 24 shown in FIG. 2B. As such, lower flange inner surface 62 is preferably spherically shaped to correspond to eyeball surface 25 of eyeball base 24. Bottom mounting bracket 16 preferably also includes external threads 64 formed on a cylindrical extension 65 of bottom mounting bracket 16t hat can mate with internal threads from bottom mounting nut 18 (as shown in FIGS. 1 and 3) so that fountain waterjet 10 can be securely, yet removably, mounted to a spa surface. Note that although bottom bracket 16 is shown as a unitary piece, it may be constructed in sections. In particular, in order to reduce manufacturing costs, it may be desirous to produce the upper section 70 (including lower flange 60) independently of second section 72 that may include external threads 64.

A representative procedure for assembling fountain waterjet 10 includes: (1) holding top mounting bracket 20 inverted in your hand or on a suitable work surface, (2) inserting eyeball base 24 such that (upper) eyeball surface 25 meets with interior surface 23 of cover 22 of top mounting bracket 20 and outlet 26 fits into and through opening 30, (3) placing bottom mounting bracket 16 such that lower flange inner surface 62 meets with a corresponding (lower) eyeball surface 25 from eyeball base 24, and (4) fastening the brackets together by gluing, screwing, or other means such that the brackets 16, 20 are fixed in relation to each other and yet the eyeball portion 19 is able to pivot in opening 30.

FIG. 3 shows a sectional side view of fountain waterjet 10 in an assembled and installed configuration on spa surface 80 of spa 82. Fountain waterjet 10 is adjustable in both direction and quantity of water flow by manipulating nozzle 40 and outlet 26. Outlet 26 can be adjusted upwards and downwards as designated by arrow A to allow aiming of the fountain, and also can be adjusted sideways to a certain extent, generally resulting in a two-dimensional range of motion limited by the shape of outlet 30. When outlet 26 is pivoted, light bracket 14 and illumination source 54 (among other components) are correspondingly pivoted. For example, if outlet 26 is pivoted downwards in the direction of arrow A, light bracket 14 and illumination source 54 would pivot upwards in the direction of arrow B such that illumination source 54, light bracket 14, eyeball throat 19, nozzle 40, and outlet 26 would remain in a linear arrangement, thus allowing light from LEDs 55 to illuminate fountain 42. Nozzle 40 and outlet 26 and therefore fountain 42 can similarly be pivoted horizontally or a combination of horizontally and vertically.

FIG. 3 illustrates a minimum or zero water flow condition through nozzle 40 wherein nozzle 40 has been screwed down into eyeball throat 27 such that nozzle base 21 is proximal to or within interim reservoir 34 and o-ring 44 meets with interim reservoir surface 46 such that little or no water can get to channel 38 to form fountain 42. Note also that although fountain waterjet 10 is illustrated as being mounted on a horizontal surface, namely spa surface 80, it is equally suitable for mounting on other inclinations, including vertical surfaces and walls.

Preferably, connections between the source water conduit (not shown) and inlet 12 as well as all other joints are as watertight as possible. If the connections between the various components of fountain waterjet 10 are not watertight, water may escape though the connections. In some cases, it may be optimal to use fillers, sealants, o-rings or the equivalent to help ensure watertight connection between the parts of fountain waterjet 10, particularly as it relates to nozzle 40 and the various conduits and/or chambers. Methods for ensuring a watertight connection between parts or plumbing parts are known by one of ordinary skill in the art. Further, the various components of fountain waterjet 10 may be attached by any appropriate means, including gluing and sonic welding.

As fountain waterjets typically are unitary devices with the individual parts having been glued, welded or otherwise adhered together, access to the interior of a fountain waterjet often is impossible. Fountain waterjets can become clogged with debris and/or sediment and, especially if a unitary device or a non-unitary device (that is, a device with component parts that can be separated form each other) with inadequate access to the interior of the device, such a device likely would have to be removed from the spa, discarded and replaced with another device. Therefore, the present invention offers an advantageous characteristic in that access can be gained to the interior of fountain waterjet 10 by removing nozzle 40. More specifically, nozzle 40 can be unscrewed and completely removed from eyeball portion 19 thus allow access to the interior of fountain waterjet 10 for cleaning. In addition, one can replace illuminating device 54 and manipulate the inlet water line from the underside/dryside of spa 82 in order to change the color of the lights, or to replace lights that have burned out.

FIG. 3 also illustrates a preferred method for mounting fountain waterjet 10 on a spa surface 80. The assembled device 10, or just the lower mounting bracket 16, is inserted into a hole formed into spa surface 80. The hole formed into spa surface 80 should be of a size and shape so as to cooperate with the size and shape of cylindrical extension 65. Once the assemble device, or just the lower mounting bracket 16, is inserted into the hole such that the lower flat surface 71 of lower mounting bracket 16 rests against spa surface 80, mounting nut 18 is screwed onto threads 64 and tightened against spa surface 80, thus securing the device 10 onto spa surface 80.

FIG. 4 is a side plan view illustrating a preferred geometry and configuration for nozzle 40. As illustrated in FIGS. 2B and 3, nozzle 40 carries an interior nozzle channel 38 as conduit for the water that becomes fountain 42. Other characteristics of nozzle 40 include preferred scalloped channel 110 that aids in conveying water into nozzle channel 38 by way of nozzle entrances 36. As shown, nozzle entrances 36 may be one or more holes or other passages that allow water to pass into nozzle channel 38. While FIG. 4 illustrates nozzle 40 having two holes as nozzle entrances 36 on opposite surfaces of nozzle 40, one or more holes, including more than two holes are suitable.

In order to adjust the amount of water flow in fountain 42, nozzle threads 112 allow nozzle 40 to be selectively moved in and out of eyeball throat 27. As illustrated in FIG. 2B, when nozzle 40 is “unscrewed” (out), fountain waterjet 10 is at maximum flow. As illustrated in FIG. 3, when nozzle 40 is “screwed in” (in), fountain waterjet 10 would be at no flow, or minimum flow. Nozzle 40 is infinitely adjustable with eyeball throat 27, and thus the fountain 42 water flow rate can be adjusted as desired by the user. Also note that outlet 26 preferably is comprised of two components, nozzle end 114 and outlet screen cap 116. Outlet screen cap 116 may be constructed integrally with, or separate from, one or more preferred outlet screens 130, as disclosed in more detail in conjunction with FIGS. 6A-6D). In the assembled condition, it is preferred that when outlet 26 is rotated, both nozzle end 114 and outlet screen cap 116 are rotated.

FIG. 5 is a frontal view of fountain waterjet 10 showing outlet screen cap 116 with a preferred outlet screen 130. As shown, it is preferred that opening 30 be of sufficient size to offer reasonable freedom of motion for repositioning of nozzle 40 by way of manipulating outlet 26. Also visible in FIG. 5 is eyeball surface 25 and cover 22.

The shape of fountain 42 can be modified by the configuration of outlet screen 130 and that one of ordinary skill in the art can modify outlet screen 130 so that fountain waterjet 10 will produce a fountain 42 of a desired shape including multiple water streams. FIGS. 6A-6D illustrate only several of a myriad of preferred outlet screens 130. FIG. 6A illustrates an outlet screen 130 with a single round fountain outlet 132 to produce a relatively continuous and smooth single stream shaped fountain. FIG. 6B illustrates an outlet screen 130 with multiple round fountain outlets 134 to produce a triple stream shaped fountain. FIG. 6C illustrates an outlet screen 130 with a “+” or “x” shaped fountain outlet 136 to produce a “+” or “x” shaped fountain. FIG. 6D illustrates an outlet screen 130 with a plurality of relatively small fountain outlets 138 to produce a more widely shaped fountain. As noted above, outlet screens 130 may either be individual or formed unitarily with outlet screen cap 116. Irrespective of whether or not outlet screen cap 116 is unitary with outlet screen 130 or merely retains it, outlet screen cap 116 should be securely, yet removably connected to nozzle end 114 to avoid inadvertent removal, such as by falling off or by being ejected by water pressure, and inadvertent noise, such as by rattling caused by water pressure.

As disclosed herein, to generate a fountain from fountain waterjet 10, water from a water source (not shown) flows into fountain waterjet 10 and, if nozzle 40 is set to allow flow, the water stream enters into interim reservoir 34, flows about nozzle base 21 and into the interior of eyeball throat 27 where it can enter the interior of nozzle 40 through nozzle entrances 36. The water then passes through a channel in nozzle 40 through optional outlet screen 130 and into the air where as a fountain 42, eventually cascades to the standing water in spa 82. In accordance with the present invention, a user can manipulate a single knob, outlet 26, to control both the velocity and direction of the water/fountain. If the user desires to illuminate the fountain 42, LEDs 55 can be activated to provide illumination to fountain 42 by passing through the transparent or translucent regions of the device 10 and into the water flow.

In operation and use, fountain waterjet 10 provides an aesthetically pleasant illuminated fountain 42 into spa 82. As fountain waterjet 10 preferably is located above the water surface of spa 82 on, for example, spa surface 80, fountain 42 can provide a smooth flow of falling water extending from fountain waterjet 10 to the water surface of the spa.

Fountain waterjet 10 can be manufactured from relatively inexpensive materials. For example, fountain waterjet 10 can be formed of plastics, ceramics, metal, or other materials. Preferably, fountain waterjet 10 can be molded or formed from a plastic material that will not corrode or be adversely affected from the exposure to water, particularly chlorinated water. Such plastics, ceramics, metals, and other materials are known in the art. Alternatively, for more elegant or expensive installations, fountain waterjet 10 can be made of more elegant or expensive materials, such as gold, silver, pewter, crystal, and the like.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. A device for producing an artificial waterfall fountain of water comprising:
a) a fountain waterjet including at least one inlet and at least one outlet for allowing water into and out of the fountain waterjet, respectively;
b) a water source providing water to the fountain waterjet; and
c) an adjustable nozzle that regulates the water flow through the device and directs the outlet from the device.

2. The device according to claim 1, wherein the nozzle is removable.

3. The device according to claim 2, wherein at least a portion of the nozzle is interchangeable to produce different patterned fountains.

4. The device according to claim 1, wherein the flow of water through the device can be shut off by turning of the nozzle and wherein the nozzle is accessible on the exterior of the fountain waterjet.

5. The device according to claim 1, wherein the nozzle is pivotable.

6. The device according to claim 2, wherein access to the interior of the device is achieved through a throat from which the nozzle has been removed, allowing for the cleaning, maintenance and repair of the device.

7. The device according to claim 1, further comprising at least one illumination source and at least one transparent conduit allowing light from the illumination source to be transferred to water flowing through the fountain waterjet so as to create an illuminated fountain of water emanating from the nozzle.

8. The device according to claim 7, wherein the illumination source is a light emitting diode.

9. The device according to claim 7, wherein at least a portion of the nozzle is comprised of a transparent material to permit light from the illumination source to be transmitted through the device and into the fountain of water.

10. The device according to claim 7, wherein at least some of the light from the illumination source reaches the outlet having passed only through transparent materials.

11. A fountain waterjet for producing a fountain of water comprising:
a) a water inlet for allowing water into the fountain waterjet and a water outlet for allowing water out of the fountain waterjet;
b) a top mounting bracket and a bottom mounting bracket that have cooperating interior surfaces that are at least partially spherically shaped;
c) an eyeball support structure at least a portion of which is spherically shaped that fits into the cooperating interior surfaces of the top mounting bracket and the bottom mounting bracket; and
d) an adjustable and pivotable nozzle that is removably secured within a throat of the eyeball support structure,
wherein the nozzle regulates the flow through the device and the direction of the fountain of water produced by the device.

12. The device according to claim 11, wherein the nozzle is removable so as to allow access to the interior of the fountain waterjet from the spa side.

13. The device according to claim 11, wherein the nozzle further comprises an interchangeable screen to produce different patterned fountains of water.

14. The device according to claim 11, wherein the flow of water through the device can be adjusted from a zero flow to and including a maximum flow and vice versa by turning of the nozzle and wherein the nozzle is accessible on the exterior of the fountain waterjet.

15. The device according to claim 11, further comprising an illumination source that emits light that is transmitted through the device to the fountain of water so as to create an illuminated fountain of water.

16. The device according to claim 15, wherein the illumination source is at least one light emitting diode.

17. The device according to claim 15, wherein at least a portion of the nozzle is comprised of a transparent material to permit light from the illumination source to be transmitted through the device and to the fountain of water.

18. The device according to claim 15, wherein at least some of the light from the illumination source reaches the outlet having passed only through transparent materials.

19. A fountain waterjet for producing a fountain of water comprising:
a) a water inlet for allowing water into the fountain waterjet and a water outlet for allowing water out of the fountain waterjet;
b) a top mounting bracket and a bottom mounting bracket that have cooperating interior surfaces that are at least partially spherically shaped;
c) an eyeball support structure at least a portion of which is spherically shaped that fits into the cooperating interior surfaces of the top mounting bracket and the bottom mounting bracket;
d) an adjustable and pivotable nozzle that is removably secured within a throat of the eyeball support structure, the nozzle being adjustable to regulate the flow of water through the device from a zero flow to and including a maximum flow, the nozzle being pivotable to adjust the direction of the fountain of water produced by the device, the nozzle being removable so as to allow access to the interior of the fountain waterjet from the spa side, and the nozzle comprising an interchangeable screen to produce different patterned fountains of water; and
e) an illumination source for illuminating the fountain of water, wherein the illumination source emits light that is transmitted through the device to the fountain of water so as to create an illuminated fountain of water,
wherein at least a portion of the nozzle is comprised of a transparent material to permit light from the illumination source to be transmitted through the device and to the fountain of water.

20. The device according to claim 19, wherein at least some of the light from the illumination source reaches the outlet having passed only through transparent materials.
